(19) United States
(12) Patent Application Publication
(10) Pub. No.: US 2018/0324367 A1
(43) Pub. Date: Nov. 8, 2018

(54) USING NIR ILLUMINATORS TO IMPROVE VEHICLE CAMERA PERFORMANCE IN LOW LIGHT SCENARIOS

(71) Applicant: Ford Global Technologies, LLC, Dearborn, MI (US)

(72) Inventors: Adil Nizam Siddiqui, Famington Hills, MI (US); Jonathan Diedrich, Carleton, MI (US)

(21) Appl. No.: 15/586,186

(22) Filed: May 3, 2017

(51) Int. Cl. H04N 5/33; H04N 7/18; H05B 33/08; B60R 1/00

(52) U.S. Cl. CPC H04N 5/33; H04N 7/183; B60R 2300/103; B60R 1/00; H05B 33/0854

(57) ABSTRACT

Method and apparatus are disclosed for using NIR illuminators to improve vehicle camera performance in low light scenarios. An example vehicle includes an illumination system, a rear-view camera, a near-infrared (NIR) illuminator integrated with the illumination system, and a control system. The control system is configured for pulsing the NIR illuminator on and off based on a frame rate of the rear-view camera, and processing images captured by the camera while the NIR illuminator is on separately from images captured while the NIR illuminator is off.

### TECHNICAL FIELD

The present disclosure generally relates to illumination for vehicle cameras and, more specifically, using near-infrared (NIR) illuminators to improve vehicle camera performance in low light scenarios.

### BACKGROUND

Modern vehicles may include one or more cameras that display images through a vehicle display. One such camera may be a rear-view camera or backup camera, which allows the vehicle display to show an area behind the vehicle when the vehicle is in reverse.

Vehicles may also include illumination systems, such as head lamps, fog lamps, reverse lights, etc., which act to illuminate the area around the vehicle. The one or more cameras may require light to operate properly, and may thus rely on the vehicle illumination systems.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown using NIR illuminators in connection with vehicle cameras. An example disclosed vehicle includes an illumination system, a rear-view camera, and a near-infrared (NIR) illuminator integrated with the illumination system. The vehicle also includes a control system for pulsing the NIR illuminator on and off based on a frame rate of the rear-view camera, and processing images captured by the camera while the NIR illuminator is on separately from images captured while the NIR illuminator is off.

An example disclosed method includes illuminating a vehicle rear-view camera field of view with an illumination system. The method also includes pulsing a near-infrared (NIR) illuminator on an off based on a frame rate of the rear-view camera, wherein the NIR illuminator is integrated with the illumination system. The method further includes processing images captured by the camera while the NIR illuminator is on separately from images captured while the NIR illuminator is off. And the method yet further includes displaying the processed images on a vehicle display.

Another example may include means for illuminating a vehicle rear-view camera field of view, means for pulsing a near-infrared (NIR) illuminator on an off based on a frame rate of the rear-view camera, means for processing images captured by the camera while the NIR illuminator is on separately from images captured while the NIR illuminator is off, and means for displaying the processed images on a vehicle display.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example rear perspective view of a vehicle according to embodiments of the present disclosure.

FIG. 2 illustrates an example block diagram of electronic components of the vehicle of FIG. 1.

FIG. 3 illustrates an example rear tail-light of a vehicle according to embodiments of the present disclosure.

FIG. 4 illustrates a flowchart of an example method according to embodiments of the present disclosure

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

As noted above, vehicles can include one or more cameras that may provide images of the vehicle surroundings. These cameras may be positioned such that a full 360 degree view can be captured.

In low light scenarios, these cameras may be deprived of light, limiting their ability to capture and process images. For instance, low light scenarios may occur at night, when a vehicle enters a tunnel, or at any other time the camera cannot capture a sufficient amount of light.

In general, a camera may produce a better image if more light is captured, so long as it does not wash out or overexpose the image. As such, some vehicles may increase an amount of light given off by one or more illumination systems of the vehicle (head lamps, fog lamps, rear lights, etc.). But many jurisdictions impose regulations on vehicles which limit the amount of visible light that can be emitted. This may be for safety reasons, so that lighting from one vehicle does not blind a driver of another vehicle.

In order to provide a clearer, more defined, and/or longer range image, example vehicles of the present disclosure may include one or more NIR illuminators. The NIR illuminators may provide the camera with additional incident light, without causing problems for a driver of another vehicle. The additional light may enable a computing system to distinguish features or objects in the image with a greater ability than images in which NIR illuminators are not used. Further, the NIR illuminators may allow the image to have a greater range, such that features and objects may be detected at a much greater range than when NIR illuminators are not used.

But NIR illuminated images may cause a discrepancy or problem with color consistency of the images. For many camera sensors, NIR light may be interpreted incorrectly as red, green, or blue light, and may cause errors in the image. To combat this problem, embodiments of the present disclosure may pulse the NIR illuminator such that some images are captured with the NIR illuminator on, and some images are captures with the NIR illuminator off. As a result, systems and devices of the present disclosure may include increased camera sensitivity and rage without sacrificing color consistency.

In some examples, a vehicle may include a camera, an illumination system, and an NIR illuminator. The NIR illuminator may be integrated with the illumination system. In this way, both the illumination system and the NIR illuminator may provide light to the field of view of the camera. The vehicle may also include a control system, which may be configured for pulsing the NIR illuminator on and off based on a frame rate of the camera.

For instance, the camera frame rate may be 30 frames per second. The camera may capture light for 1/30 seconds, and sum the incident light over that time period in order to determine the frame. This process may be done 30 times per second. In some examples, the NIR illuminator may be pulsed on and off at a rate of 15 times per second, such that the NIR illuminator is on for frame 1, off for frame 2, etc. The resulting image frames may be processed and displayed to a user, such that the images of the camera may include increased visibility and range while maintaining color consistency.

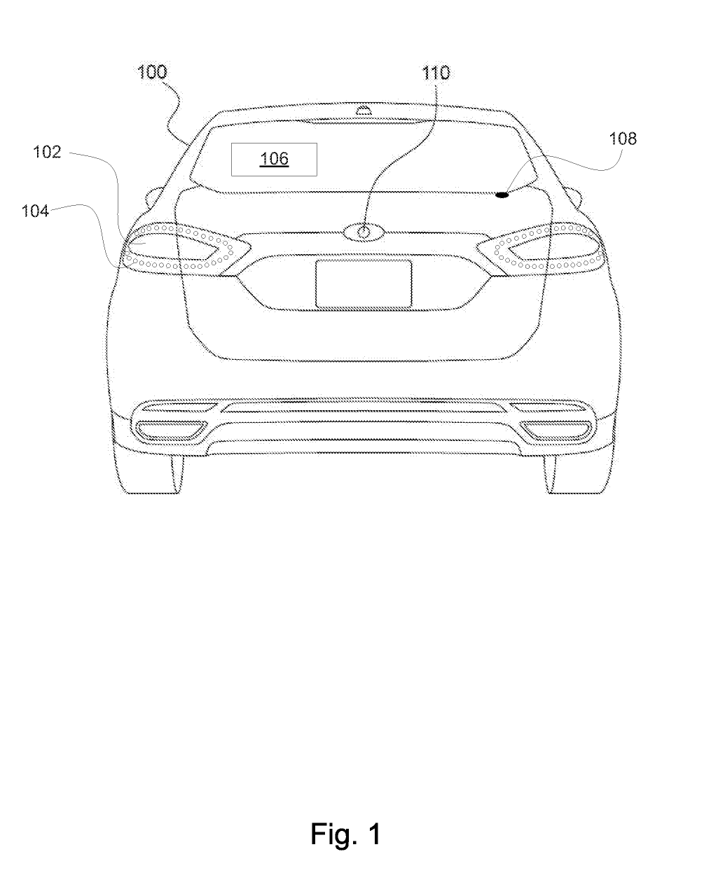

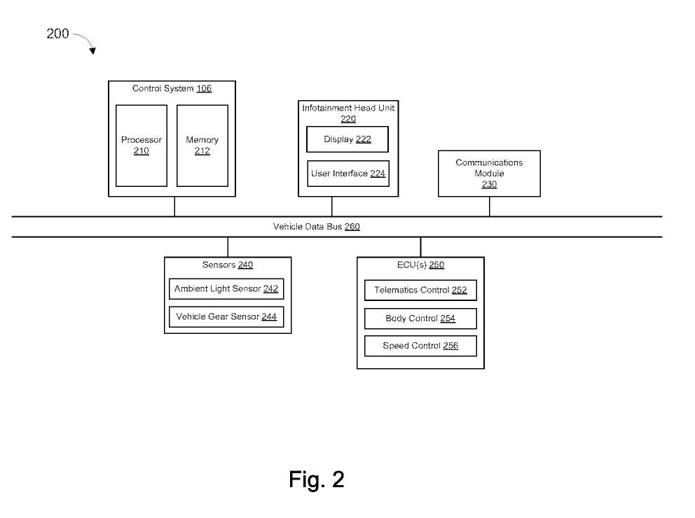

FIG. 1 illustrates an example vehicle 100 according embodiments of the present disclosure. Vehicle 100 may be a standard gasoline powered vehicle, a hybrid vehicle, an electric vehicle, a fuel cell vehicle, or any other mobility implement type of vehicle. Vehicle 100 may be non-autonomous, semi-autonomous, or autonomous. Vehicle 100 includes parts related to mobility, such as a powertrain with an engine, a transmission, a suspension, a driveshaft, and/or wheels, etc. In the illustrated example, vehicle 100 may include one or more electronic components (described below with respect to FIG. 2).

As shown in FIG. 1, vehicle 100 may include an illumination system 102, a near-infrared illuminator (NIR) 104, an on-board computing platform 106, an ambient light sensor 108, and a rear-view camera 110.

Illumination system 102 may include one or more lights or light emitting devices configured to illuminate a field of view of the driver of the vehicle, one or more vehicle cameras, and/or one or more vehicle sensors. For example, illumination system 102 may include one or more headlamps, auxiliary lamps, turn signal lights, rear position lamps, brake lights, the center high mount stop lamp (CHMSL), and license plate light. Further, illumination system 102 may include one or more incandescent lamps, light emitting diodes (LEDs), high intensity discharge (HID) lamps, neon lamps, or other lighting sources. In some examples, the illumination system 102 may be a dedicated light for the camera 110.

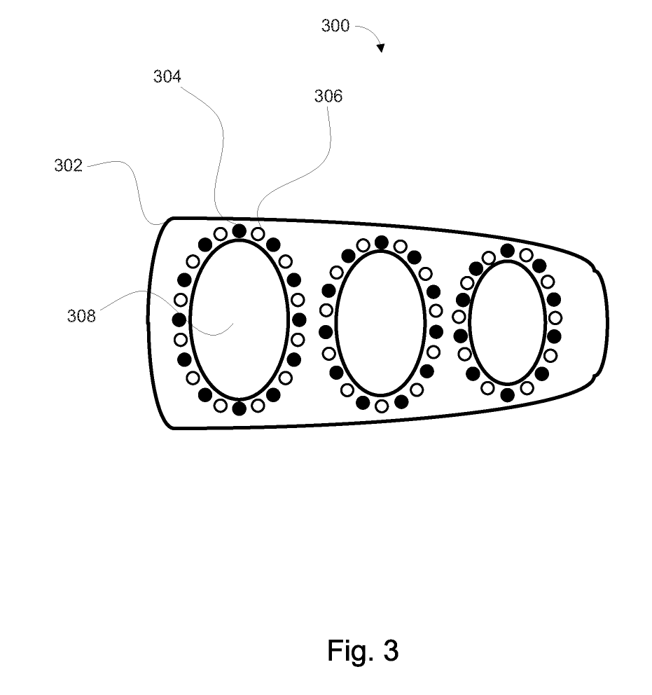

Vehicle 100 may also include an NIR illuminator 104. In some examples, NIR illuminator 104 may include a plurality of NIR LEDs or other NIR light source. The NIR LEDs may be interspersed with LEDs of the illumination system. This is shown in further detail in FIG. 3.

NIR illuminator 104 may be configured to emit light at a particular wavelength or range of wavelengths. For example, infrared light is light with a wavelength around 700 nm and larger. NIR light may therefore include light from around 700 nm up to 3000 nm or larger.

Some NIR illuminators, however may have an upper limit of 750 nm, and may be configured to emit light below 750 nm. NIR illuminators may also be configured to emit light at higher or lower wavelengths, and/or to emit light that is not visible to the human eye.

NIR illuminator 104 may be controlled by one or more other vehicle systems, such as on-board computing platform 106. In some examples, NIR illuminator 104 may be controlled to pulse on and off at a particular frequency or with a particular pattern.

Vehicle 100 may also include a camera 110. Camera 110 may be a rear-view camera, forward facing camera, side-facing camera, or any other vehicle camera. Camera 110 may be configured to capture images to be displayed on a display of vehicle 100, which may include a center console display, an instrument panel display, a display on a vehicle rear-view mirror, a hand held device display, or some other display.

Camera 110 may operate at a particular frame rate. As noted above, a camera frame rate may be 30 frames per second. This may mean that the camera accumulates light for 1/30 seconds, summing or otherwise processing the incident light over that time period in order to determine the frame, completing this process 30 times per second.

In some examples, for each frame camera 110 may collect light for less than 1/30 seconds (i.e., less than the time period available for the given frame). For instance, where the camera operates in a brightly lit environment, the camera may operate at 30 frames per second, but capturing each frame may include accumulating light for less than the available time-period of the frame (e.g., 1/60 seconds rather than 1/30 seconds). The exact amount of time for collection may depend on the amount of light incident on the camera, such that an image frame can be determined based on the incident light. Where there is a large amount of incident light, the camera may collect light for less than the available time period for each frame to avoid washing out or over exposing the image.

Alternatively, in low light scenarios, the camera may accumulate light for the entire time period available for each frame. But in many cases even this amount of time may not be enough to produce a useable image frame. Instead, the image frame may be too dark and may not include enough contrast for objects or features to be detected.

In some examples, camera 110 may operate with a particular gain, which can act to adjust the image. The gain value may change based on the amount of light collected for a given frame. For instance, where there is a low amount of light collected by the camera, the gain may be increased. This gain increase may increase the signal coming from the camera, but may also increase the level of noise. As such, increasing the gain requires consideration of a trade-off between increased signal and keeping the noise level low.

Camera 110 may also include one or more filters. In some examples, camera 110 may limit the wavelength of incident light with a cut-off filter. For instance, the filter may limit light with a wavelength greater than 750 nm from reaching the camera sensor. In practice, an IR cutoff filter may be a band pass filter which limits light in a particular band of wavelengths.

Vehicle 100 may also include an on-board computing platform 106, which may also be called a control system or computing system. On-board computing system 106 may include one or more processors, memory, and other components configured to carry out one or more functions, acts, steps, blocks, or methods described herein. On-board computing system 106 may be separate from or integrated with the systems of vehicle 100.

In some examples, on-board computing system 106 may be configured for controlling the camera 110, illumination system 102, and/or NIR illuminator 104. On-board computing system 106 may pulse NIR illuminator 104 on and off based on the frame rate of the camera. As mentioned above, the camera may operate with a particular frame rate, which may indicate how many frames per second are captured by the camera. On-board computing system 106 may pulse NIR illuminator 104 at a particular pulse rate based on the camera frame rate, such as 100%, 50%, or some other pulse rate. Further, on-board computing system 106 may pulse NIR illuminator 104 on and off with a particular duty cycle (i.e., a 50% duty cycle in which NIR illuminator is on for 50% of the time and off for 50% of the time). As such, for each frame captured by camera 110, NIR illuminator 104 may be (i) on or off, and (ii) if on, may only be on for a portion of the time interval in which the camera accumulates incident light for the frame.

In some examples, such as where there is low light, NIR illuminator 104 may be pulsed on for the entire time interval used to accumulate light for a given frame. This may enable greater light capture by camera 110 such that resulting images may have greater definition, and objects or features in the image frame can be more readily detected.

In some examples, on-board computing system 106 may pulse NIR illuminator on and off and a rate 50% less than the camera frame rate. In this example, half the frames captured by the camera may include exposure to NIR light, and half may not. On-board computing system 106 may also pulse NIR illuminator 104 on for a first length of time, and then off for a second length of time, wherein the first length of time corresponds to a length of time for which the rear-view camera accumulates signal for each frame. This may be a duty cycle for NIR illuminator 104, which may depend on one or more characteristics of camera 110.

In some examples, embodiments of the present disclosure may include determining that vehicle 100 and/or camera 110 are operating in a low light state. In order to determine this, one or more sensors, computing devices, and/or algorithms may be used. For instance, ambient light sensor 108 may detect a level of ambient light. When the amount of detected light is below a threshold amount, that may indicate the vehicle is operating in a low light state.

In some examples, determining the low light state may include determining the low light state based on a gain applied to a signal from the camera. For instance, camera 110 and/or on-board computing system 106 may apply a larger gain to images captured by camera 110 when the amount of incident light is low. As such, where the camera or processor applies a larger amount of gain (i.e., above a threshold amount), that may indicate that the camera 110 is operating in a low light state.

In some examples, an amount of time for which the camera accumulates incident light may be used to determine that the camera is in a low light state. For instance, the camera may have a frame rate that determines a time interval over which the camera accumulates light for each frame. Where the camera accumulates light for the entire interval, that may indicate the camera is not receiving a high amount of incident light, and may be operating in a low light state.

Responsive to any determination that the camera and/or vehicle is in a low light state, on-board computing system 106 may responsively activate NIR illuminator 104.

On-board computing system 106 may also be configured for processing images captured by the camera while the NIR illuminator is on separately from images captured while the NIR illuminator is off. Separate processing may include applying one or more separate filters, algorithms, and/or image processing techniques to each set of images. Further, on-board computing system 106 may process the two sets of images separately in part, and may combine the two sets of images, or perform some processing on both sets of images together. Further, separate processing of images may include partial or completely separate processing in time, wherein batches of images are processed together. Other processing techniques can be used as well.

Where two sets of images are captured and processed (those with NIR on and those with NIR off), this enables one set to be used for a first purpose, while the second set can be used for a second purpose. For instance, images captured with the NIR off may be used to determine color data, and to maintain color consistency. These images are captured such that NIR light does not affect the camera, and the true red, green, and blue values can more easily be detected. On the other hand, the set of images captured with the NIR illuminator on may provide added contrast, definition, and object detection ability. The added NIR light in these images may enable less intensive image processing, may provide a user with a greater range of view, and may provide other benefits.

FIG. 2 illustrates an example block diagram 200 showing electronic components of vehicle 100, according to some embodiments. In the illustrated example, the electronic components 200 include the control system 106, infotainment head unit 220, communications module 230, sensors 240, electronic control unit 250, and vehicle data bus 260.

The control system 106 may include a microcontroller unit, controller or processor 210 and memory 212. The processor 210 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 212 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 212 includes multiple kinds of memory, particularly volatile memory and non-volatile memory.

The memory 212 may be computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 212, the computer readable medium, and/or within the processor 210 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 220 may provide an interface between vehicle 100 and a user. The infotainment head unit 220 may include one or more input and/or output devices, such as display 222, and user interface 224, to receive input from and display information for the user(s). The input devices may include, for example, a control knob, an instrument panel, a digital camera for image capture and/or visual command recognition (such as camera 110 in FIG. 1), a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (LCD), an organic light emitting diode (OLED) display, a flat panel display, a solid state display, etc.), and/or speakers. In the illustrated example, the infotainment head unit 220 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). In some examples the infotainment head unit 220 may share a processor with control system 106. Additionally, the infotainment head unit 220 may display the infotainment system on, for example, a center console display of vehicle 100.

Communications module 230 may include wired or wireless network interfaces to enable communication with the external networks. Communications module 230 may also include hardware (e.g., processors, memory, storage, etc.) and software to control the wired or wireless network interfaces. In the illustrated example, communications module 230 may include a Bluetooth module, a GPS receiver, a dedicated short range communication (DSRC) module, a WLAN module, and/or a cellular modem, all electrically coupled to one or more respective antennas.

The cellular modem may include controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); and Wireless Gigabit (IEEE 802.11ad), etc.). The WLAN module may include one or more controllers for wireless local area networks such as a Wi-FI® controller (including IEEE 802.11 a/b/g/n/ac or others), a Bluetooth® controller (based on the Bluetooth® Core Specification maintained by the Bluetooth Special Interest Group), and/or a ZigBee® controller (IEEE 802.15.4), and/or a Near Field Communication (NFC) controller, etc. Further, the internal and/or external network(s) may be public networks, such as the Internet; a private network, such as an intranet; or combinations thereof, and may utilize a variety of networking protocols now available or later developed including, but not limited to, TCP/IP-based networking protocols.

Communications module 230 may also include a wired or wireless interface to enable direct communication with an electronic device (such as a smart phone, a tablet computer, a laptop, etc.). An example DSRC module may include radio(s) and software to broadcast messages and to establish direct connections between vehicles. DSRC is a wireless communication protocol or system, mainly meant for transportation, operating in a 5.9 GHz spectrum band.

Sensors 240 may be arranged in and around the vehicle 100 in any suitable fashion. In the illustrated example, sensors 240 includes an ambient light sensor 242 and a vehicle gear sensor 244. Ambient light sensor 242 may measure an amount of ambient light. One or more cameras or other systems of the vehicle may require a threshold amount of light to operate, and or may trigger an action based on the amount of light sensed by the ambient light sensor 242. Vehicle gear sensor 244 may indicate what gear the vehicle is in (e.g., reverse, neutral, etc.). One or more actions may be taken by the various systems and devices of vehicle 100 based on a determined gear. The various sensors of vehicle 100 may be analog, digital, or any other type, and may be coupled to one or more other systems and devices described herein.

One or more of the sensors 240 may be positioned in or on the vehicle. For instance, ambient light sensor 242 may be positioned on or near a window of the vehicle such that the sensor 242 is not covered and can measure an amount of ambient light.

The ECUs 250 may monitor and control subsystems of vehicle 100. ECUs 250 may communicate and exchange information via vehicle data bus 260. Additionally, ECUs 250 may communicate properties (such as, status of the ECU 250, sensor readings, control state, error and diagnostic codes, etc.) to and/or receive requests from other ECUs 250. Some vehicles 100 may have seventy or more ECUs 250 located in various locations around the vehicle 100 communicatively coupled by vehicle data bus 260. ECUs 250 may be discrete sets of electronics that include their own circuit(s) (such as integrated circuits, microprocessors, memory, storage, etc.) and firmware, sensors, actuators, and/or mounting hardware. In the illustrated example, ECUs 250 may include the telematics control unit 252, the body control unit 254, and the speed control unit 256.

The telematics control unit 252 may control tracking of the vehicle 100, for example, using data received by a GPS receiver, communication module 230, and/or one or more sensors. The body control unit 254 may control various subsystems of the vehicle 100. For example, the body control unit 254 may control power windows, power locks, power moon roof control, an immobilizer system, and/or power mirrors, etc. The speed control unit 256 may receive one or more signals via data bus 260, and may responsively control a speed, acceleration, or other aspect of vehicle 100.

Vehicle data bus 260 may include one or more data buses that communicatively couple the control system 106, infotainment head unit 220, communications module 230, sensors 240, ECUs 250, and other devices or systems connected to the vehicle data bus 260. In some examples, vehicle data bus 260 may be implemented in accordance with the controller area network (CAN) bus protocol as defined by International Standards Organization (ISO) 11898-1. Alternatively, in some examples, vehicle data bus 250 may be a Media Oriented Systems Transport (MOST) bus, or a CAN flexible data (CAN-FD) bus (ISO 11898-7).

FIG. 3 illustrates an example rear-tail light 300 according to embodiments of the present disclosure. Tail light 300 may one example arrangement, and should not be understood to limit the scope of the present disclosure. Tail light 300 may include a housing 302, a plurality of illumination system LEDs 304, a plurality of NIR LEDs 306, and one or more other light elements 308.

As shown in FIG. 3, the NIR LEDs 306 may be integrated with the illumination system LEDs 304 in an “every-other LED” arrangement. Some examples may include other arrangements, and may have more or fewer LEDs. Further, some example lighting systems may not include illumination system LEDs at all, and may include only NIR LEDs integrated with the standard vehicle lighting system.

In some examples, the NIR LEDs 306 may be oriented such that they aim or are pointed in the same direction as the illumination system LEDs 304. Alternatively, one or more NIR LEDs 306 may be pointed in a different direction, such that the NIR LEDs provide a greater or smaller field of illumination. Still further, one or more NIR LEDs 306 may be configured to change their orientation via one or more actuators, such that they can be dynamically aimed by one or more systems or devices Other variations are possible as well.

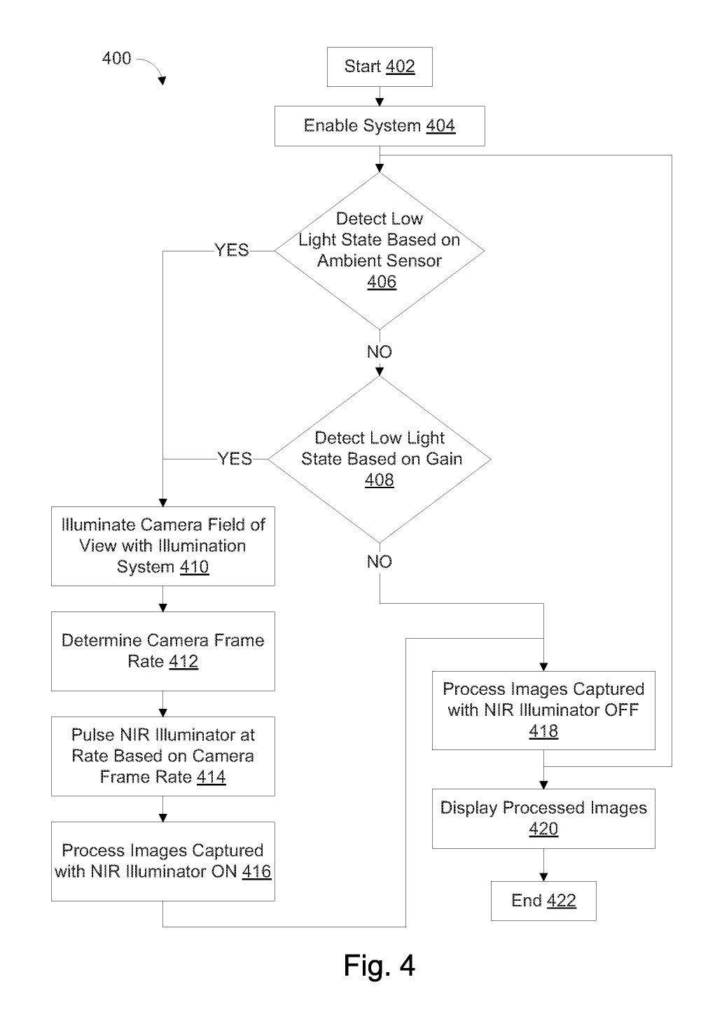

FIG. 4 illustrates a flowchart of an example method 400 according to embodiments of the present disclosure. Method 400 may enable a vehicle camera (and user) to view images with greater range and clarity in low light scenarios. The flowchart of FIG. 4 is representative of machine readable instructions that are stored in memory (such as memory 212) and may include one or more programs which, when executed by a processor (such as processor 210) may cause vehicle 100 and/or one or more systems or devices to carry out one or more functions described herein. While the example program is described with reference to the flowchart illustrated in FIG. 4, many other methods for carrying out the functions described herein may alternatively be used. For example, the order of execution of the blocks may be rearranged or performed in series or parallel with each other, blocks may be changed, eliminated, and/or combined to perform method 400. Further, because method 400 is disclosed in connection with the components of FIGS. 1-3, some functions of those components will not be described in detail below.

Method 400 may start at block 402. At block 404, the system may be enabled. This may include turning on, initializing, or otherwise preparing one or more systems or devices for operation.

At block 406, method 400 may include detecting a low light state based on an ambient sensor. As described above, an ambient sensor may detect when a level of light is below a threshold. The threshold may be a set value or may be dynamic, may be predetermined, or may be selected based on one or more sensors or systems of the vehicle. For instance, the threshold may be set based on the quality of image produced under certain lighting conditions, to avoid situations in which the image quality drops too low.

If a low light state is not detected by the ambient light sensor, block 408 may include detecting a low light state based on a gain applied to a signal of the camera. As discussed above, the camera gain may be high under certain lighting conditions, and a high gain may indicated that the camera is operating in a low light state. It should be noted that blocks 406 and 408 are described as being performed in series, however they may be performed in parallel, reverse order, and either block may not be performed at all. Further, additional blocks (not shown) may be included in which alternate techniques for detecting a low light state are used.

If a low light state is detected based on either the ambient light sensor or based on the gain, block 410 may include illuminating the camera field of view with the vehicle illumination system. This may include turning on headlights, rear lights, or other vehicle lights.

At block 412, method 400 may include determining a camera frame rate. As discussed above, the camera frame rate may indicate how many frames per second are captured by the camera, which may correspond to the length of time the camera accumulates light for each frame.

At block 414, method 400 may include pulsing the NIR illuminator at a pulse rate based on the camera frame rate. For example, the pulse rate may be 50% of the camera frame rate, meaning that the NIR illuminator is on for half of the frames captured by the camera, and off for half. Method 400 may also include synchronizing the camera with the NIR illuminator, such that the NIR illuminator pulse on begins at the same or nearly the same time as the beginning of a frame capture time period.

The camera may then capture images over a given time period in which some frames include NIR illumination and some frames do not. At block 416, method 400 may include processing images captured with the NIR illuminator on. This may include using one or more filters, algorithms, processes, or other image processing techniques to obtain one or more processed images. These processed images may be brighter, may enable feature or object detection, or otherwise may provide different options than images that were not captured with the NIR illuminator on.

At block 418, method 400 may include processing images captured with the NIR illuminator off. Processing these images may be similar or identical to the processing of the images captured with the NIR illuminator on. In some examples, block 418 may include applying a color correction process to the images to maintain color consistency. Other image processing techniques may be used as well.

At block 420, method 400 may include displaying the processed images. This may include combining the ‘NIR on’ images with the ‘NIR off’ images to achieve a composite image, in which color consistency is maintained, and greater range and object detection is achieved. As such, the displayed images may achieve a best-of-both-worlds result in that range and detection are increased, without sacrificing color consistency. The processed images may be displayed on any display of the vehicle, including a center console, a heads up display, an instrument panel, a rear-view mirror display, or a hand held display coupled to the vehicle.

Method 400 may then continue to pulse the NIR illuminator, capture images, process the images, and display the images until a low light state is no longer detected, or some other action is taken (such as turning off camera). Then at block 422, method 400 may end.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
an illumination system;
a rear-view camera;
a near-infrared (NIR) illuminator integrated with the illumination system; and
a control system for:
pulsing the NIR illuminator on and off based on a frame rate of the rear-view camera; and
processing images captured by the camera while the NIR illuminator is on separately from images captured while the NIR illuminator is off.

2. The vehicle of claim 1, wherein the illumination system comprises a set of LED lights.

3. The vehicle of claim 2, wherein the NIR illuminator comprises a set of NIR LEDs mounted between the illumination system set of LED lights.

4. The vehicle of claim 1, wherein the NIR illuminator is configured to emit light below 750 nm.

5. The vehicle of claim 1, wherein the control system is further for:
determining that the rear-view camera is in a low light state; and
responsively activating the NIR illuminator.

6. The vehicle of claim 5, wherein determining that the rear-view camera is in a low light state is based on a gain applied to an image captured by the camera.

7. The vehicle of claim 5, wherein determining that the rear-view camera is in a low light state is based on an ambient light sensor.

8. The vehicle of claim 1, wherein pulsing the NIR illuminator on and off based on a frame rate of the rear-view camera comprises pulsing the NIR illuminator at half the rate of the rear-view camera, such that half the images captured by the rear-view camera are exposed to NIR light and half the images are not.

9. The vehicle of claim 1, wherein pulsing the NIR illuminator comprises repeatedly turning the illuminator on for a first length of time, and then off for a second length of time, wherein the first length of time corresponds to a length of time for which the rear-view camera accumulates signal for each frame.

10. The vehicle of claim 1, wherein the control system is further for determining color data based on the images captured while the NIR illuminator is off.

11. The vehicle of claim 1, further comprising a cutoff filter for suppressing light emitted by the NIR illuminator to between 700 and 750 nm.

12. A method comprising:
illuminating a vehicle rear-view camera field of view with an illumination system;
pulsing a near-infrared (NIR) illuminator on an off based on a frame rate of the rear-view camera, wherein the NIR illuminator is integrated with the illumination system;
processing images captured by the camera while the NIR illuminator is on separately from images captured while the NIR illuminator is off; and
displaying the processed images on a vehicle display.

13. The method of claim 12, wherein the illumination system comprises a set of LED lights, and wherein the NIR illuminator comprises a set of NIR LEDs mounted between the illumination system LED lights.

14. The method of claim 12, wherein the NIR illuminator is configured to emit light below 750 nm.

15. The method of claim 12, further comprising:
determining that the rear-view camera is in a low light state; and
responsively activating the NIR illuminator.

16. The method of claim 15, wherein determining that the rear-view camera is in a low light state is based on a gain applied to an image captured by the camera.

17. The method of claim 15, wherein determining that the rear-view camera is in a low light state is based on an ambient light sensor.

18. The method of claim 12, wherein pulsing the NIR illuminator on and off based on a frame rate of the rear-view camera comprises pulsing the NIR illuminator at half the rate of the rear-view camera, such that half the images captured by the rear-view camera are exposed to NIR light and half the images are not.

19. The method of claim 12, wherein pulsing the NIR illuminator comprises repeatedly turning the illuminator on for a first length of time, and then off for a second length of time, wherein the first length of time corresponds to a length of time for which the camera accumulates signal for each frame.

20. The method of claim 12, further comprising determining color data based on the images captured while the NIR illuminator is off.
